(19) United States
(12) Patent Application Publication
(10) Pub. No.: US 2013/0290329 A1
(43) Pub. Date: Oct. 31, 2013

(54) Legal Relationship Manager

(71) Applicant: Charles Lee Moore, San Francisco, CA (US)

(72) Inventor: Charles Lee Moore, San Francisco, CA (US)

(73) Assignee: ROCKET LAWYER INCORPORATED, San Francisco, CA (US)

(21) Appl. No.: 13/872,357

(22) Filed: Apr. 29, 2013

Related U.S. Application Data
(60) Provisional application No. 61/639,972, filed on Apr. 29, 2012.

(51) Int. Cl. G06F 17/30

(52) U.S. Cl. CPC G06F 17/30011
USPC 707/736

(57) ABSTRACT

A computer implemented legal relationship manager tracks documents, provisions, public filings, address books, social media information, personal and business activities and produces a plurality of online interview interfaces to gather information for a user knowledge database. A relationship manager subsystem accepts information from the user knowledge database and produces analysis, including charts and graphs and other useful displays to help users with their legal circumstances. A recommendation engine produces recommendations for third party products and further actions within the system.

### RELATED PATENT APPLICATION AND INCORPORATION BY REFERENCE

This is a utility application based upon U.S. patent application Ser. No. 61/639,972 filed on Apr. 29, 2012. This related application is incorporated herein by reference and made a part of this application. If any conflict arises between the disclosure of the invention in this utility application and that in the related provisional application, the disclosure in this utility application shall govern. Moreover, the inventor(s) incorporate herein by reference any and all patents, patent applications, and other documents hard copy or electronic, cited or referred to in this application.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

(1) Field of the Invention

The invention generally relates to mapping legal relationships. More particularly, the invention relates to mean and methods of organizing legal associations among people, places, organizations, assets and liabilities to create a course of action, graph and map to a guide a user through various legal matters.

(2) Description of the Related Art

Other computer based legal assistance systems are known in the prior art. For example, U.S. Pat. No. 7,558,782 “Network Based Legal Services System” issued on Jul. 7, 2009 to Meltzer et al discloses an interface allowing clients to enter into retainer agreements over a network. A retained client may then post inquires to a legal service provider.

U.S. Pat. No. 7,158,944 “Method and Apparatus for Facilitating the Selection of Legal and Legal-Related Service Providers” issued on Jan. 2, 2007 to Settle discloses a computer system facilitating consumers becoming clients of a system and protecting a client's confidential information and avoiding conflicts of interest within the system.

The known prior art fails to provide consumers an overall plan of action regarding their legal affairs. Thus, there is a need in the art for the various embodiments of the present invention.

### BRIEF SUMMARY OF THE INVENTION

The present invention overcomes shortfalls in the related art by presenting an unobvious and unique combination, configuration of methods, systems and components to create overall legal plans for consumers. Unlike the related art, embodiments of the present invention review the totality of a consumer's potential legal needs, assets, obligations and relationships.

Disclosed embodiments also include the use of custom software, database tools, processors, and other items to graph or map actual, potential and desired legal associations, links or inter-relationships. As social, work and family relationships become richer and more complex in the Digital Age, new means and methods are needed to assist a consumer in selecting the correct legal documents and actions after careful consideration of the consumer's legal needs, assets, obligations and relationships.

Disclosed embodiments may include means and methods of collecting data from a variety of sources such as social media, contact lists and postings. User information is also obtained by use of online interviews with alternative lines of questions triggered by a consumer's previous responses and other user data. Embodiments of the system include means and methods of identifying and analyzing risk, considering such factors as the level and state of documentation of known relationships.

For example, a user “Joe” may join a disclosed system wherein the system will build a Legal Relationship Profile. After Joe answers questions and the system accepts data from other sources, the system may discover that Joe is a carpenter, operating as a sole proprietorship and that Joe is engaged to be married to Jane. The system may recommend that Joe:
document his pending marital relationship with Jane with a Pre-marital Agreement;
incorporate his business as a Limited Liability Company (“Newco”), creating a new Legal Person and Legal Relationship; and
document his new legal relationship with Newco with an LLC Operating Agreement.

The system may also integrate Joe's potential other legal needs and offer help with legal agreements with wedding planners and other appropriate vendors. An optional vendor side of the system may be implemented wherein wedding vendors and other vendors may be vetted and if appropriate, presented in a listing to Joe and Jane.

Disclosed embodiments excel in mapping the totality of a user's attributes, assets and relationships to produce a comprehensive and overarching map of legal action.

These and other objects and advantages will be made apparent when considering the following detailed specification when studied in conjunction with the drawings.

### BRIEF DESCRIPTION OF THE DRAWINGS

FIG. 1 depicts several disclosed components

FIG. 2 depicts a pseudo screen view of an intake interface

FIG. 3 depicts a pseudo screen view of an intake interface

FIG. 4 depicts a pseudo screen view of an electronic signature interface

FIG. 5 depicts a pseudo screen view of a system generated recommendation

FIG. 6 depicts a pseudo screen view of a timeline of user activity

FIG. 7 depicts a pseudo screen view of an activity log

FIG. 8 depicts a pseudo screen view of a main page of a user interface

FIG. 9 depicts a pseudo screen view of a property management interface

FIG. 10 depicts machine readable instructions stored upon non-transitory medium in communication with a processor and other components

Reference Numerals in the Drawings.

100 process or module or subsystem gathering information about a user via use of online interviews, address books, public filings, user postings, uploaded documents and other sources.

110 social or professional networks of a user

120 address books or lists of a user

125 public filings or public documents of a user

130 uploaded documents provided by a user

140 an interactive remote interview process

142 a plurality of online interview interfaces

150 an action panel

151 a make a document command interface

152 a consult a lawyer command interface

153 a help and guidance command interface

160 user input area in response to online interview interfaces

161 a lease agreement interface

162 document subject to the interface and user input

165 ask a lawyer interface

170 a document process panel

172 progress update on data entered into the subject document

174 index of people involved in a subject document

175 interview status report

176 document completion status report

178 lawyer review status report

180 esign or electronic signature interface

181 instructions regarding electronic signatures

185 a recent activity log

186 a timeline of activity

187 an associations information panel

190 an interface showing interactions with a selected person

191 a panel showing documents related to a selected person

192 an interface allowing notes to be written and stored regarding a selected person

195 an interface allowing for the creation and storage of user folders

197 a user interface displaying user documents

200 a user knowledge database

300 a relationship manager subsystem wherein all relationships recorded within the overall system may be are gathered, studied, processed, analyzed and later mapped to legal documents, other clients, vendors and legal plans of action

310 a user of the system

320 family of a user

330 home or other asset of a user

340 an employer of a user

342 employees of a user

344 partners of a user

400 a user profile database

500 a recommendation engine wherein the mapping of user needs, relationships, assets and other variables may generate a recommendation to a user or vendor

510 a system generated and transmitted recommendation

600 a sharing and collaboration module

700 a server in communication with or comprising a processor 720

710 non-transitory storage medium containing machine readable instructions, the instructions not being signals

720 a processor in communication with the non-transitory storage medium 710 and memory 730, the processor being a general processor or specialized processor

730 memory in communication with the processor 720

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

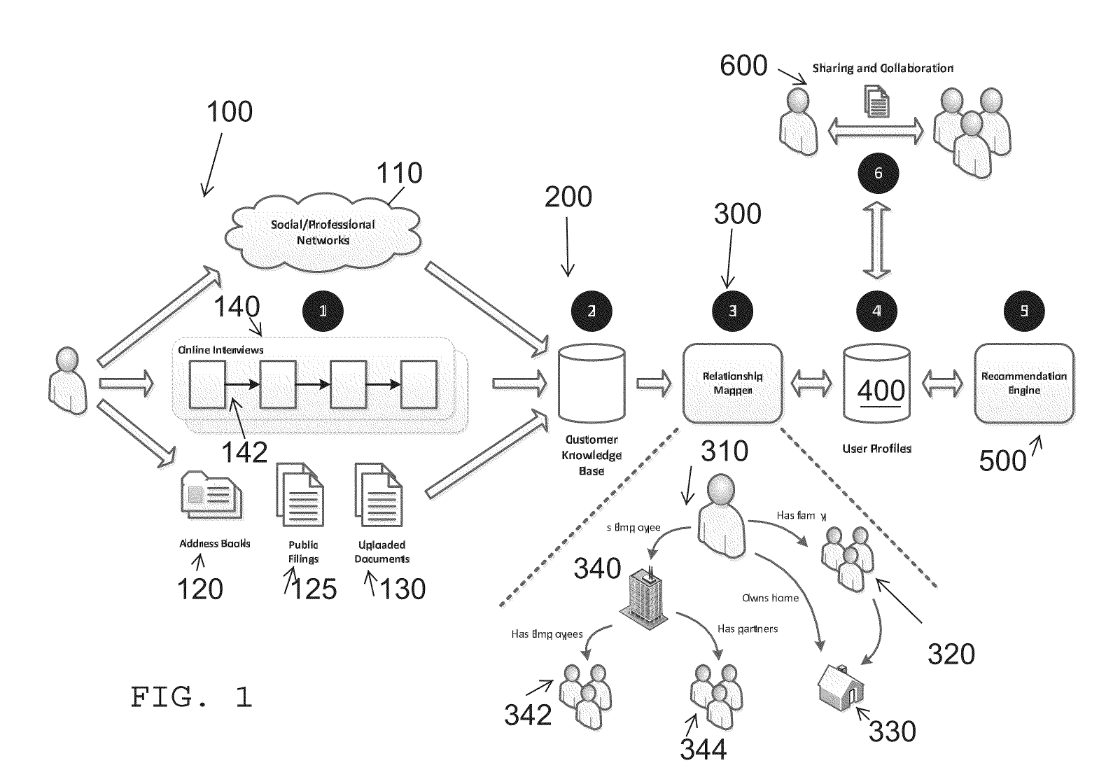

FIG. 1 depicts a disclosed system including a process or system 100 including one or more social or professional networks 110, address books 120, public filings 125 and user entered or uploaded documents 130. An interactive and remote interview process 140 may include a plurality of online interview interfaces 142, as shown in more detail in subsequent figures.

User input or information including social and professional networks 110, online interview information, address books, public filings uploaded documents may be transmitted to and stored within a user knowledge database 200.

Data from the user database 200 may enter a relationship manager subsystem 300, the relationship manager subsystem 300 graphing or mapping user relationships with employers 340, employees 342 and partners 344, as well as family members 320 and user assets 330 such as a home.

Information mapped, categorized or otherwise organized or changed by the relationship manager subsystem 300 may be entered into a user profile database 400 for further analysis, modification or distribution. Information from the user profile database 400 may be shared with a recommendation engine 500 for the system production of recommendations to third party vendors, recommendations for the drafting of further legal documents or for other recommendations.

Information from the user profile database 400 may be transmitted or shared with a sharing and collaboration module 600.

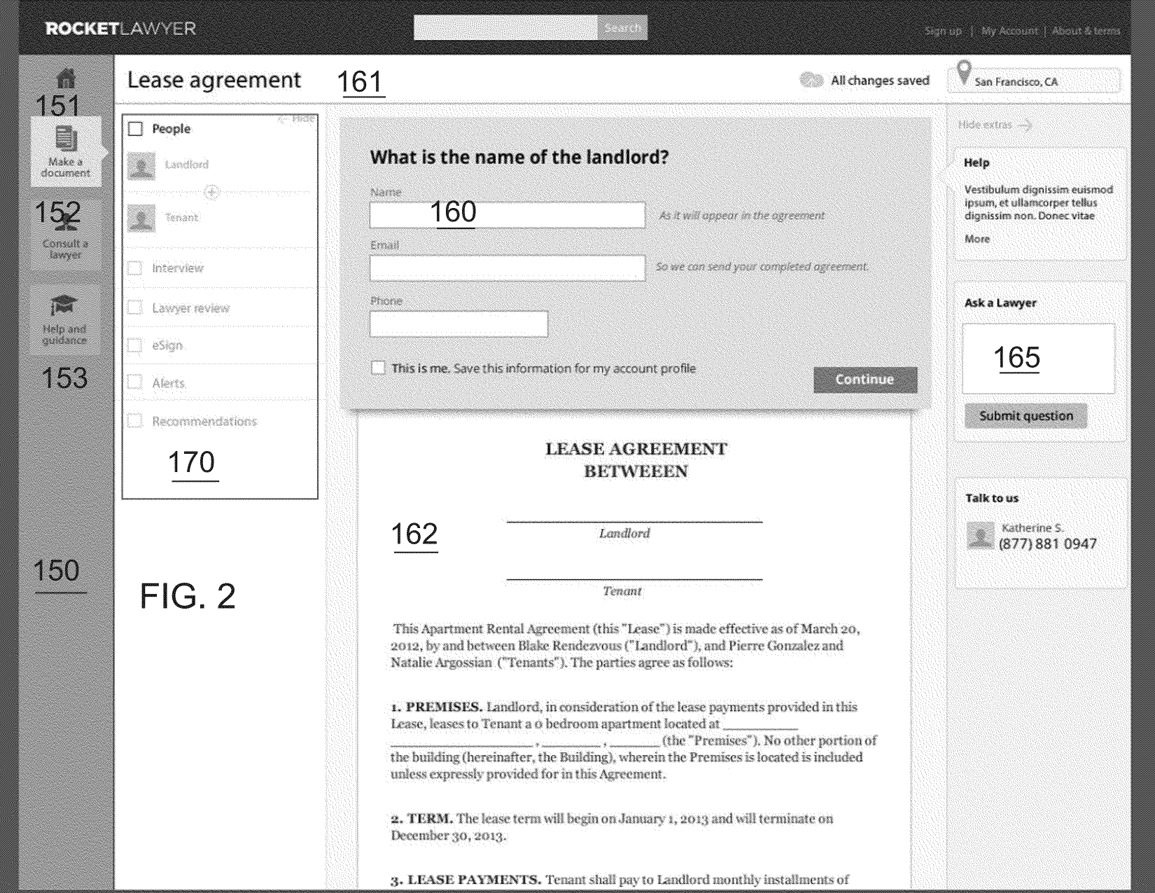

FIG. 2 depicts a user interface pertaining to a lease agreement, but other types of agreements and legal documents are also presented in similar means. An action panel 150 includes a make a document interface 151, a consult a lawyer 152 command interface and a help and guidance 153 command interface. FIG. 2 also comprises a user interface area 160 pertaining to a subject document 162, for purposes of illustration, a lease document is displayed. The text or portions of the text of a subject document 162 are displayed to help the user understand the process. A document process panel 170 shows the progress of document creation, associated persons, and other information. FIG. 2 also contains an ask a lawyer interface 165 wherein questions address to lawyers may be transmitted.

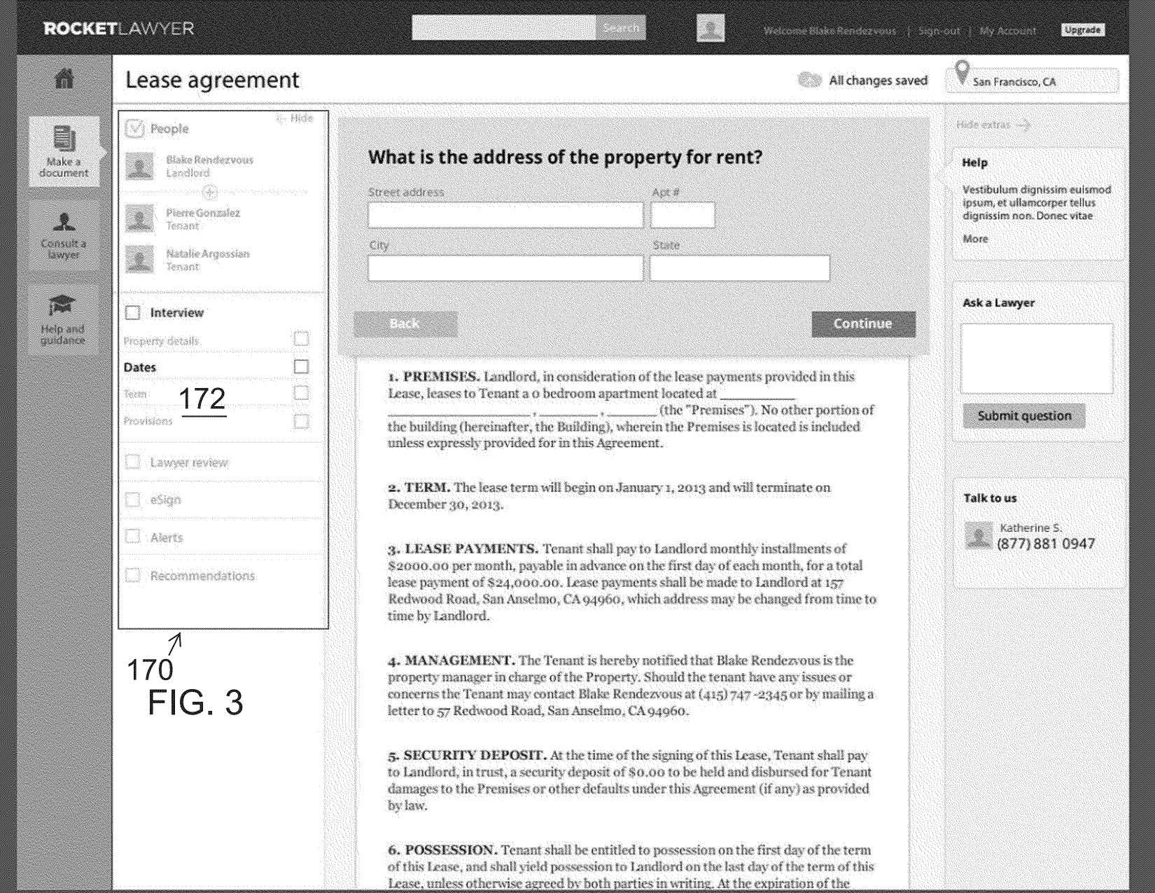

FIG. 3 depicts an expanded document process panel 170 which includes a progress update 172 on data entered into the subject document.

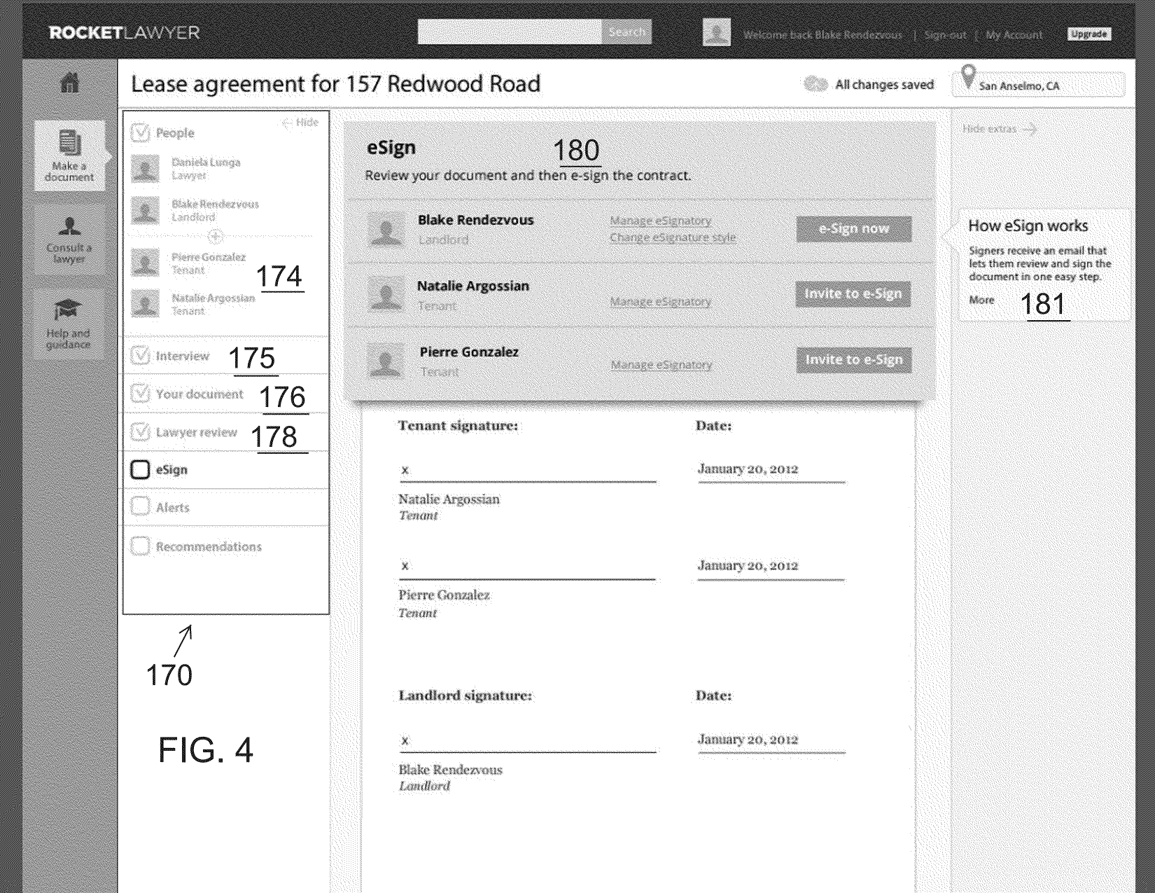

FIG. 4 depicts a further expanded document process panel 170 further comprising an index of people 174 involved in a subject document, an interview status report 175, a document completion status report 176, and lawyer review status report 178. FIG. 4 also depicts an esign or electronic signature interface 180 with an instruction panel having instructions 181 regarding electronic signatures.

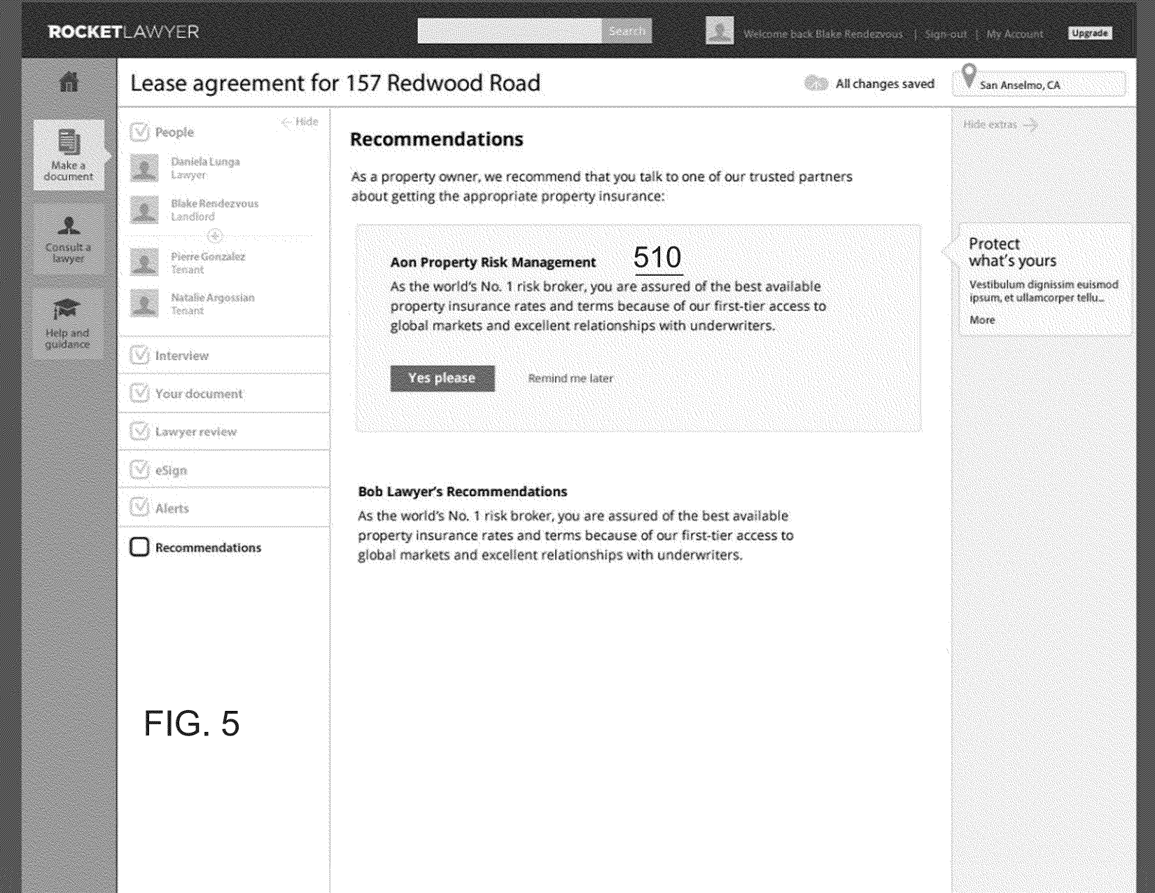

FIG. 5 depicts a system generated and transmitted recommendation 510. Recommendations to third party vendors or recommendations for further system action are generated. Recommendations are generated in a number of methods. For example, recommendations are based upon activities of other users. If a significant number of users completed document B after competing document A, a new user completing document A would receive a recommendation to consider document B. Recommendations may include third party offers and system generated recommendations based upon input from system administrators.

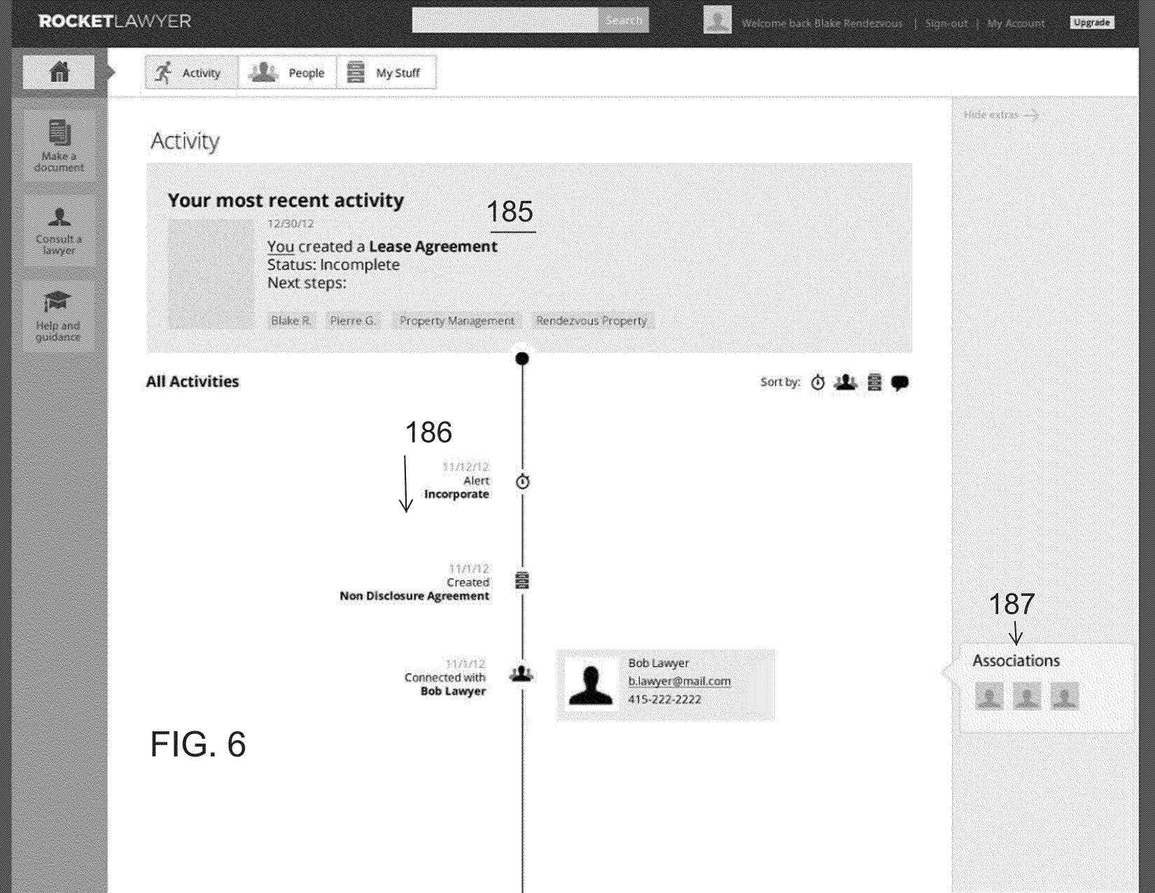

FIG. 6 depicts a recent activity log 185, a timeline of activity 186 and an associations 187 information panel. A graph of system activities is shown. A sort function allows for viewing of alerts, connections/relationships, documents and user comments.

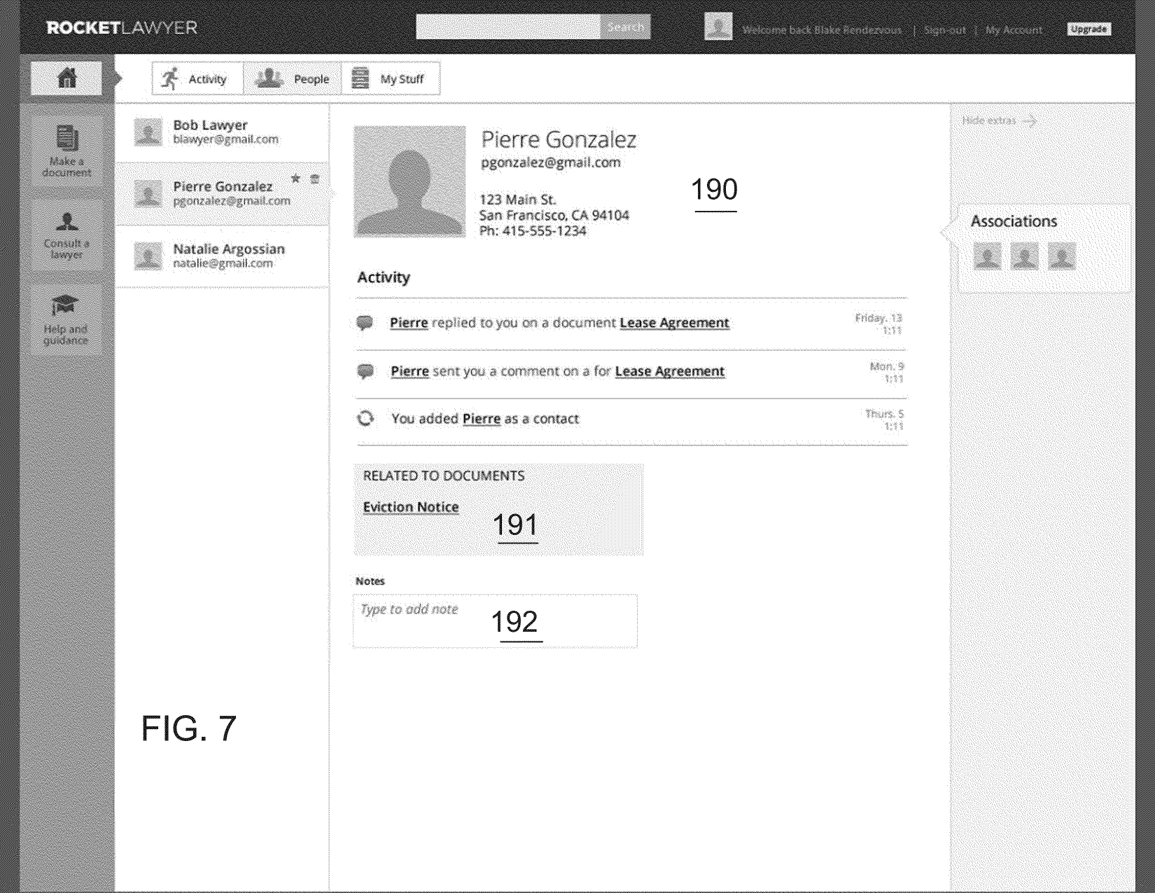

FIG. 7 depicts an interface 190 showing interactions with a selected person. Such interactions include related documents 191. An interface to add notes 192 is included.

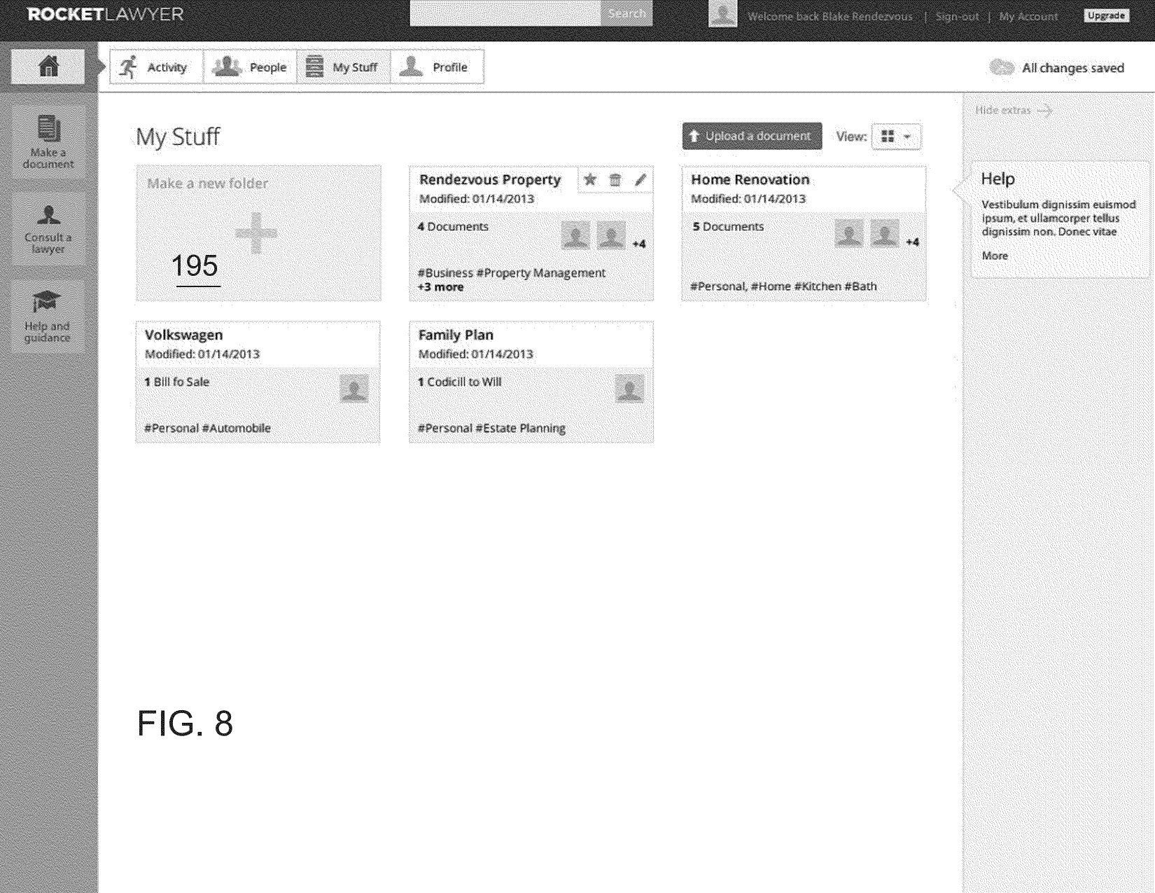

FIG. 8 depicts a user interface 195 allowing users to upload, create and store information and to make user folders. The interface and related databases allow a user to create folders for documents for safe keeping, akin to a legal vault. Users may upload non-system documents. Documents entered into a disclosed system may be electronically signed, shared with others upon the direction of the document owner and reviewed by counsel upon request.

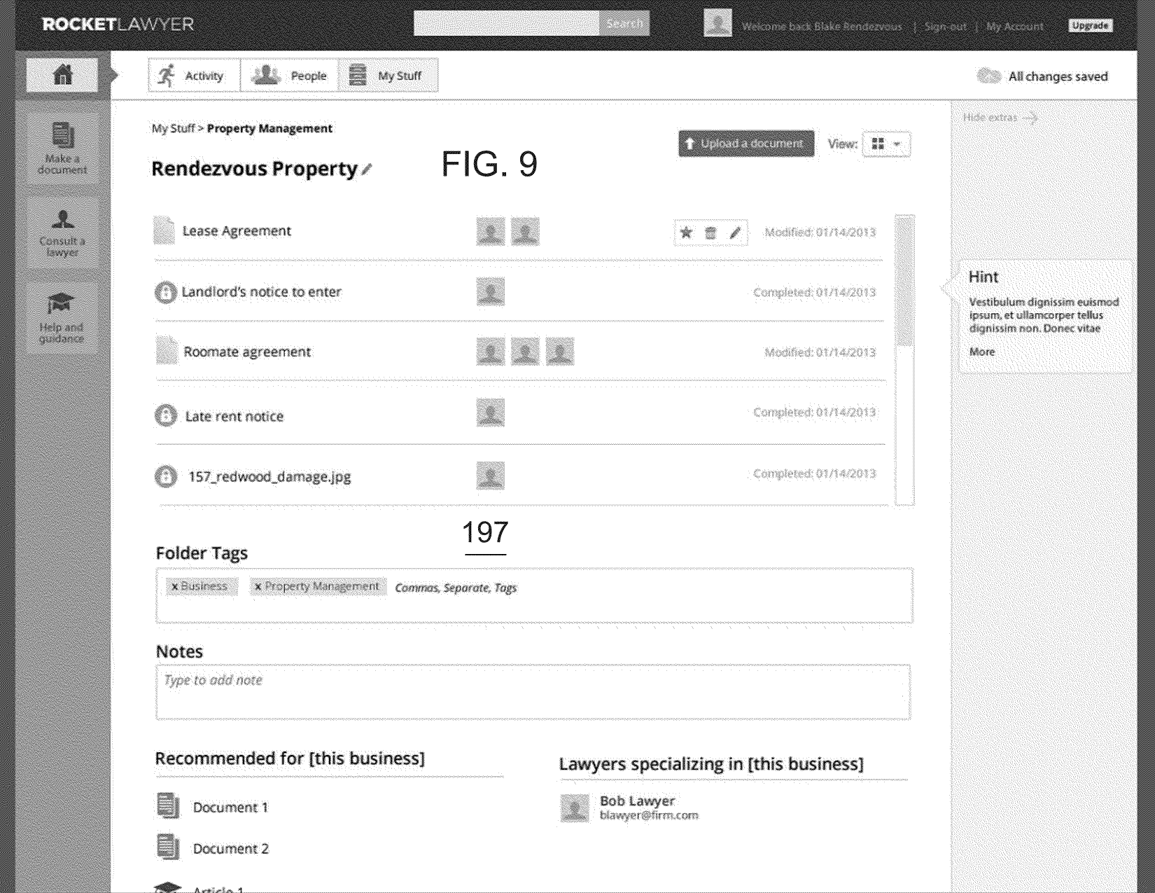

FIG. 9 depicts a user interface 197 displaying user documents and allowing for the addition of user notes, folder tags and other information. The contents of folders may be viewed. A place of record function stores documents signed by all parties and locks such documents such that no changes may be made. A list of local lawyers of relevant qualifications may be displayed. Folders may be tagged or marked with user selected information or tags. Operators of a disclosed system may view such folder tags to influence the generation of recommendations. Recommendation may be generated by examinations of a user's relationships, obligations, assets, past documents and other user information.

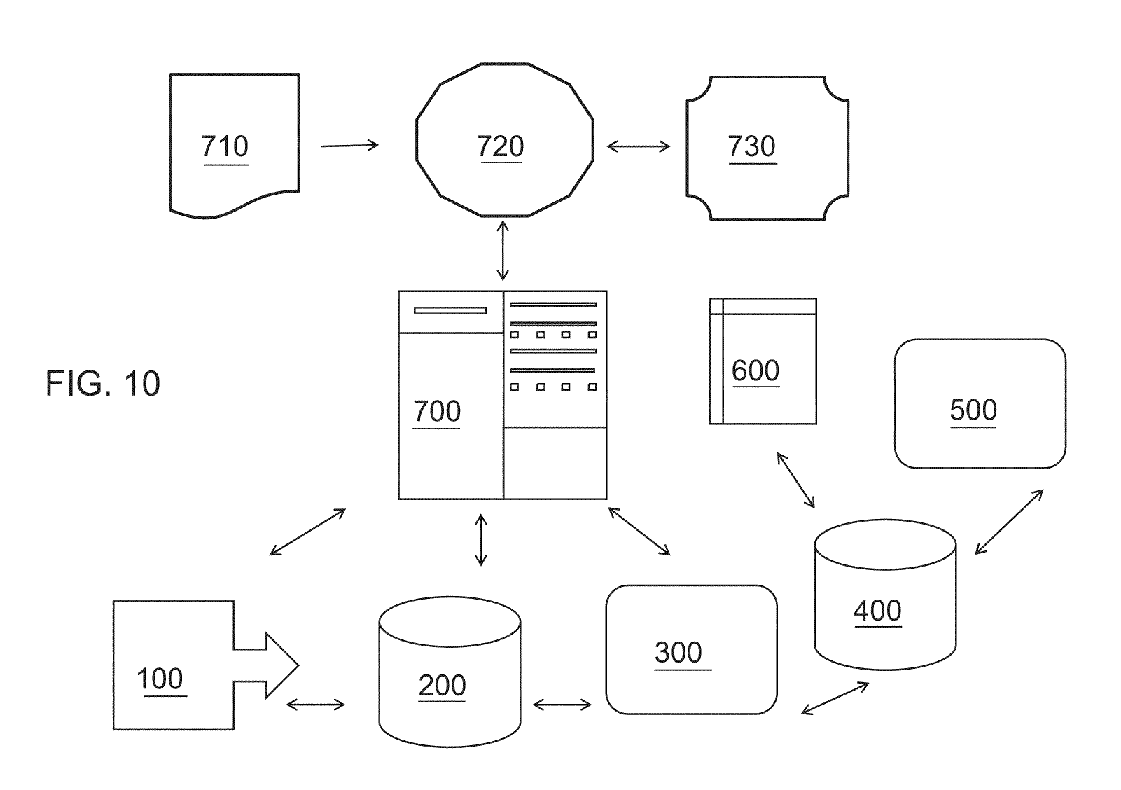

FIG. 10 depicts a disclosed system using a non-transitory storage medium 710 holding or containing machine readable instruction, the instructions consistent with the disclosed embodiments and the instructions executed by a processor 720, the processor in communication with memory 730 and the processor in communication with a server 700, the server in communication with users of the system. The server 700 is also in communication with the interfaces and other processes 100 gathering information about a user as further shown in FIG. 1, the user knowledge database 200, the relationship manager 300 subsystem, the user profile database 400, the recommendation engine 500 and the sharing and collaboration module.

Disclosed embodiments include the following items.

Item 1. A system providing legal relationship management, the system comprising:
a) a server 700 in communication with a processor 720 with the processor in communication with a non-transitory storage medium 710, the non-transitory storage medium containing machine readable instructions, and the processor in communication with memory 730;
b) the server in further communication with an information gathering module 100;
c) the information gathering module in communication with a user knowledge database 200;
d) the user knowledge database in communication with relationship manager subsystem 300,
e) the relationship manager subsystem in communication with a user profile database 400; and
f) the user profile database in communication with a recommendation engine 500 and a sharing and collaboration module 600.

Item 2. The system of item 1 wherein the information gathering module 100 comprises:
a) a plurality of online interview interfaces 142;
b) a user address book 120, public filings 125 of a user and a user's uploaded documents.

Item 3. The system of item 2 wherein the plurality of online interactive interfaces comprise:
a) an action panel 150, the action panel comprising a make a document 151 command interface, a consult a lawyer command 152 interface and a help and guidance 153 command interface; and
b) an document process panel 170, the document process panel comprising an index 174 of people involved with a subject document, an interview status report 175, document completion status report 176 and a lawyer review status report 178.

Item 4. The system of item 3 wherein one or more of the online interactive interfaces comprises an electronic signature 180 interface.

Item 5. The system of Item 1 wherein the recommendation engine produces recommendations to users based upon the recorded actions of previous users.

Item 6. A method of managing legal relationships and producing legal documents, the method comprising the steps of:
a) using machine readable instructions stored upon a non-transitory storage medium 710 with the machine readable instructions executed by a processor 720, the processor sending instructions to a server 700 and the server in communication with a computer used by a user and the server in communication with a user information module 100, a user knowledge database 200, a relationship manger subsystem 300, a user profile database 400, a recommendation engine 500 and a sharing and collaboration module 600;
b) using the user information module to generate a plurality of online interview interfaces 142 to conduct an interactive remote interview process of users 140,
c) accept address books 120, public filings 125 and documents 130 from users;
d) using an action panel 150 upon the online interview interfaces, the action panel comprising a make a document 151 command interface; a consult a lawyer 152 command interface and a help and guidance 153 command interface;
e) transmitting information from the user information module to the user knowledge database to generate legal documents based upon user input.

Item 7. The method of item 6 further comprising the use of a document process panel 170 upon an online interview interface, the document process panel comprising:
a) progress update on data 172 entered into a subject document;
b) an index 174 of people involved in a subject document;
c) an interview status report 175; and
d) a document completion status report 176.

Item 8. The method of item 7 further including the step of using a document process panel further comprising a lawyer review status report and an electronic signature interface.

Item 9. The method of item 7 further including the step of transmitting information from the user knowledge database 200 to the relationship manager sub subsystem 300 to map users of the system to legal documents, vendors and plans of legal action.

Item 10. The method of item 9 further including the step of transmitting information from the relationship manager sub system 300 to the user profile database wherein the user profile database stores user information, including user relationship data and such data is transmitted to the recommendation engine 500 to produce recommendations to the users.

Item 11. The method of item 10 further including the step of using the recommendation engine to store information from third party vendors to produce recommendations to users.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

What is claimed is:

1. A system providing legal relationship management, the system comprising:
a) a server in communication with a processor with the processor in communication with a non-transitory storage medium, the non-transitory storage medium containing machine readable instructions, and the processor in communication with memory;
b) the server in further communication with an information gathering module;
c) the information gathering module in communication with a customer knowledge database;
d) the customer knowledge database in communication with relationship manager subsystem;
e) the relationship manager subsystem in communication with a user profile database; and
f) the user profile database in communication with a recommendation engine and a sharing and collaboration module.

2. The system of claim 1 wherein the information gathering module comprises:
a) a plurality of online interview interfaces;
b) a user address book, public filings of a user and a user's uploaded documents.

3. The system of claim 2 wherein the plurality of online interactive interfaces comprise:
a) an action panel, the action panel comprising a make a document command interface, a consult a lawyer command interface and a help and guidance command interface; and
b) a document process panel, the document process panel comprising an index of people involved with a subject document, an interview status report, document completion status report and a lawyer review status report.

4. The system of claim 3 wherein one or more of the online interactive interfaces comprises an electronic signature interface.

5. The system of claim 1 wherein the recommendation engine produces recommendations to users based upon the recorded actions of previous users.

6. A method of managing legal relationships and producing legal documents, the method comprising the steps of:
a) using machine readable instructions stored upon a non-transitory storage medium with the machine readable instructions executed by a processor, the processor sending instructions to a server and the server in communication with a computer used by a customer and the server in communication with a customer information module, a customer knowledge database, a relationship manger subsystem, a user profile database, a recommendation engine and a sharing and collaboration module;
b) using the customer information module to generate a plurality of online interview interfaces to conduct an interactive remote interview of customers;
c) accept address books, public filings and documents from users;
d) using an action panel upon the online interview interfaces, the action panel comprising a make a document command interface; a consult a lawyer command interface and a help and guidance command interface;
e) transmitting information from the customer information module to the customer knowledge database to generate legal documents based upon customer input.

7. The method of claim 6 further comprising the use of a document process panel upon an online interview interface, the document process panel comprising:
a) progress update on data entered into a subject document;
b) an index of people involved in a subject document;
c) an interview status report; and
d) a document completion status report.

8. The method of claim 7 further including the step of using a document process panel further comprising a lawyer review status report and an electronic signature interface.

9. The method of claim 7 further including the step of transmitting information from the customer knowledge database to the relationship manager sub subsystem to map users of the system to legal documents, vendors and plans of legal action.

10. The method of claim 9 further including the step of transmitting information from the relationship manager sub system to the user profile database wherein the user profile database stores user information, including user relationship data and such data is transmitted to the recommendation engine to produce recommendations to the users.

11. The method of claim 10 further including the step of using the recommendation engine to store information from third party vendors to produce recommendations to users.
